(19) United States
(12) Patent Application Publication
(10) Pub. No.: US 2012/0137608 A1
(43) Pub. Date: Jun. 7, 2012

(54) FLEXIBLE WRAPPED INSULATED GLASS UNIT SPACER, SYSTEM AND METHOD FOR MANUFACTURING SAME IN SITU AND AN INSULATED GLASS UNIT HAVING A FLEXIBLE WRAPPED SPACER

(75) Inventors: Phil David Plant, Zelienople, PA (US); Kevin Wehner, Zelienople, PA (US)

(73) Assignee: BILLCO MANUFACTURING INCORPORATED, Zelienople, PA (US)

(21) Appl. No.: 13/231,013

(22) Filed: Sep. 13, 2011

Related U.S. Application Data
(60) Provisional application No. 61/382,299, filed on Sep. 13, 2010.
(60) Provisional application No. 61/390,429, filed on Oct. 6, 2010.
(60) Provisional application No. 61/485,743, filed on May 13, 2011.

(51) Int. Cl. E06B 3/663; B23P 11/00

(52) U.S. Cl. 52/204.593; 29/428; 428/68; 428/45

(57) ABSTRACT

A spacer for an insulated glass unit includes a spacer frame with a back surface and a pair of opposed sides which define a hollow interior, wherein desiccant material is introduced into the hollow interior through the back surface at a series of spaced locations along the back surface and the back surface of the spacer frame is subsequently sealed. A flexible spacer is disclosed with a hollow interior which is sufficiently flexible as to be supplied in coil form to an IG assembly line. The flexibility can be provided to the spacer through the construction of a thin-walled profile, a plurality of kerfs or notches across the back of the spacer frame into the sides, a plurality of kerfs or notches across the front of the spacer frame into the sides, a plurality of kerfs or notches across the opposed sides of the spacer frame, and mixtures and combinations of these design features.

### RELATED APPLICATIONS

This application claims priority to U.S. Patent Application Ser. No. 60/382,299, entitled “Flexible Wrapped Insulated Glass Unit Spacer, System for Manufacturing Same and an Insulated Glass Unit having a Wrapped Spacer”, filed Sep. 13, 2010.

This application claims priority to U.S. Patent Application Ser. No. 61/390,429, entitled “Flexible Wrapped Insulated Glass Unit Spacer, System for Manufacturing Same and an Insulated Glass Unit having a Wrapped Spacer”, filed Oct. 6, 2010.

This application claims priority to U.S. Patent Application Ser. No. 61/485,743, entitled “Flexible Wrapped Insulated Glass Unit Spacer, System for Manufacturing Same and an Insulated Glass Unit having a Wrapped Spacer”, filed May 13, 2011.

### BACKGROUND INFORMATION

1. Field of the invention

The present invention relates to insulated glass units, and more particular to a flexible wrapped spacer for use in insulated glass units and methods and apparatus for manufacturing the flexible spacer in situ.

2. Background Information and Prior Art

Insulating glass units (IGUs) are used in windows to reduce heat loss from building interiors during cold weather. IGUs can also be referenced as “insulated glazing”, “insulated glass”, “double glazing”, “double glazed units” which are phrases common in Europe. Other identifications of IGUs commonly used can include “Insulating Glass Assemblies” and simply “IG.” All of the terms or phrases reference a structure having multiple panes, typically of glass, or “lites” assembled into units. IGUs use the thermal and acoustic insulating properties of a gas, and/or partial vacuum, contained in the space between the lites formed by the unit. IGUs provide excellent insulation properties without sacrificing transparency. Transparency is a critical measurement in most such units and is also referenced or measured as visual transmittance or VT. Commercially most IGUs are “double glazed” meaning there are two panes or lites, but IGUs with three panes or lites (or more), i.e. “triple glazing” is becoming more common due to higher energy costs.

IGUs are typically formed by a spacer sandwiched between glass lites. A spacer usually comprises a frame structure extending peripherally about the unit, a sealant material adhered both to the glass lites and the frame structure, and a desiccant for absorbing atmospheric moisture within the unit. The margins of the glass lites are flush with or, more commonly, extend slightly outwardly from the spacer. The sealant extends continuously about the spacer's frame structure periphery and its opposite sides so that the space within the IGUs is hermetically sealed.

One type of prior art IGU spacer was constructed from an elongated corrugated sheet metal strip-like frame embedded in a body of hot melt sealant material. Desiccant was also embedded in the sealant. The resulting composite spacer was packaged for transport and storage by coiling it in large coils into drum-like containers. When fabricating an IGU the composite spacer was partially uncoiled and cut to length. The spacer was then bent or formed into a rectangular shape and sandwiched between conforming glass lites.

One known IGU spacer is formed as a roll formed aluminum or steel rigid frame elements connected at their ends to form a square or rectangular spacer frame. The frame sides and corners were covered with sealant (e.g., a hot melt material) for securing the frame to the glass lites. The sealant provided a barrier between atmospheric air and the IGU interior which blocked entry of atmospheric water vapor. Particulate desiccant deposited inside the tubular frame elements communicated with air trapped in the IGU interior to remove the entrapped airborne water vapor and thus preclude its condensation within the unit. Thus after the water vapor entrapped in the IGU was removed, internal condensation only occurred when the unit failed.

In some cases of prior art IGU spacer construction, sheet metal was roll formed into a continuous generally ridged tube, with desiccant inserted, and fed to cutting stations where “V” shaped notches were cut in the tube at corner locations. The tube was then cut to length for the entire spacer frame, and bent into an appropriate frame shape. The continuous spacer frame, with an appropriate sealant in place, was then assembled in an IGU.

Alternatively, in other known IGU spacer configurations individual roll formed spacer frame tubes were cut to length and “corner keys” were inserted between adjacent frame element ends to form the corners. In some constructions the corner keys were foldable so that the sealant could be extruded onto the frame sides as the frame moved linearly past a sealant extrusion station. The frame was then folded to a rectangular configuration with the sealant in place on the opposite sides. The spacer assembly thus formed was placed between glass lites and the IGU assembly completed.

IGUs have failed because atmospheric water vapor infiltrated the sealant barrier. Infiltration in some prior art spacer designs tended to occur at the frame corners because the opposite frame sides were at least partly discontinuous there. For example, frames where the corners were formed by cutting “V” shaped notches at corner locations in a single long tube. The notches enabled bending the tube to form mitered corner joints, but afterwards potential infiltration paths extended along the corner parting lines substantially across the opposite frame faces at each corner.

Similarly, in some prior art IGUs employing corner keys, potential infiltration paths were formed by the junctures of the keys and frame elements. Furthermore, when such frames were folded into their final forms with sealant applied, the amount of sealant at the frame corners tended to be less than the amount deposited along the frame sides. Reduced sealant at the frame corners tended to cause vapor leakage paths.

Glass Equipment Development, Inc.'s U.S. Pat. No. 5,361,476, discloses a method and apparatus for making IGUs wherein a thin flat strip of sheet material is continuously formed into a channel shaped spacer frame having corner structures and end structures, the spacer thus formed is cut off, sealant and desiccant are applied and the assemblage is bent to form a spacer assembly.

GED Integrated Solutions, Inc.'s U.S. Patent Publication Number 2009-0014493 discloses a method and apparatus for transferring elongated window component stock from one station to another station in an elongated window component production line.

Formtek Metal Forming, Inc.'s U.S. Patent Publication Number 2008-0134627 discloses a window spacer and corner-fastening assembly that include a self-alignment system that does not require any additional hardware to hold the corners together.

Infinite Edge Technologies, LLC's U.S. Patent Publication Numbers 2009-0120036 and 2009-0120035 disclose a “box spacer” configuration for insulated glass units (IGUs). Infinite Edge Technologies, LLC's U.S. Patent Publication Number 2009-0120019 discloses a reinforced spacer design for IGUs. Infinite Edge Technologies, LLC's U.S. Patent Publication Number 2009-0120018 discloses an IGU spacer with a “stabilizer.” These publications represent some recent proposed developments in spacer technology.

Allmetal, Inc.'s U.S. Patent Publication Number 2009-0107085 discloses a molded window spacer connector for joining opposed spacer frame members.

Met-Coil Systems Corporation's U.S. Pat. No. 6,360,420 discloses an integral metal spacer for an IGU with a method of forming the same.

U.S. Patent Publication Number 2010-0065580 discloses a method and apparatus for applying desiccant to spacer frame assemblies used in constructing insulating glass units.

U.S. Pat. No. 7,449,224 discloses a spacer profile for an insulated glass unit that comprises a binder matrix forming the spacer. U.S. Pat. No. 6,823,644 discloses a spacer frame tubing configuration for IGUs. U.S. Pat. No. 6,272,811 discloses one frame with corner key spacer configuration.

Billco Manufacturing Incorporated's U.S. Patent Publication Number 2007-0074803 discloses dual head horizontal automatic flexible spacer and/or sealant applicator for a glass work piece that applies the flexible spacer and/or sealant along a single axis and will operate on a range of work pieces sizes. This reference is also descriptive of the state of the art of IGU spacers.

3M is the assignee of U.S. Pat. No. 6,846,378 entitled “Tape applicator and methods of applying tape to a surface” which also relates to U.S. Pat. Nos. 6,793,758, 6,634,401 and 6,571,849.

Additionally relevant prior art is disclosed in U.S. Pat. No. 5,013,377 that discloses a hand held spacer applicator device. U.S. Pat. No. 5,433,818 discloses apparatus for turning a glass work piece and for applying a sealing strip continuously along its edges.

Cardinal is the assignee of U.S. Pat. No. 6,793,971 entitled “Methods and devices for manufacturing insulating glass units.”

EdgeSeal is the assignee of U.S. Pat. No. 6,068,720 entitled “Method of manufacturing insulating glass units.”

Lafond is the assignee of U.S. Pat. No. 6,378,586 which describes an “Apparatus for automated application of spacer material for window assembly.”

U.S. Pat. No. 6,329,030 is directed to a “Composite insulated glass assembly and method of forming same” and U.S. Pat. No. 6,279,292 is directed to an “Insulated glass window spacer and method for making window spacer.” U.S. Pat. No. 6,148,890 is directed to an “Apparatus for the automated application of spacer material and method of using same” and U.S. Pat. No. 5,975,181 is directed to a “Strip applying hand tool with corner forming apparatus.” U.S. Pat. No. 5,888,341 (entitled “Apparatus for the automated application of spacer material”).

Lenhardt is the assignee of U.S. Pat. No. 6,609,611 entitled “Device for conveying insulating glass panes”; U.S. Pat. No. 5,319,186 entitled “Apparatus for controlling the movement of a tool along the edge of glass panes”; and U.S. Pat. No. 4,561,929 entitled “Apparatus for applying an adhesive strip of plastic to a glass pane”.

Lisec is the assignee of U.S. Pat. No. 4,434,024 entitled “Device for assembling insulating glass panes”; U.S. Pat. No. 5,823,732 entitled “Device for moving insulating glass panes”; U.S. Pat. No. 5,394,725 entitled “Apparatus for the production of spacer frames for insulating glass panes from hollow profile strips”; a U.S. Pat. No. 5,173,148 entitled “Installation for the production of insulating glass”; U.S. Pat. No. 4,961,816 entitled “Apparatus for emplacing spacers”; U.S. Pat. No. 4,961,270 entitled “Apparatus for determining the spacing between glass sheets of insulating glass panes”; U.S. Pat. No. 4,885,926 entitled “Apparatus for the production of spacer frames”; U.S. Pat. No. 4,769,105 entitled “Device for the mounting of flexible spacers”; and U.S. Pat. No. 4,743,336 entitled “Device for mounting flexible spacers on glass sheets.”

Lockformer Company is the assignee of U.S. Pat. No. 6,038,825 entitled “Insulated glass window spacer and method for making window spacer.”

Manser is the assignee of U.S. Pat. No. 5,932,062 entitled “Automated sealant applicator.”

PPG is the assignee of U.S. Pat. No. 6,470,561 entitled “Spacer and spacer frame for an insulating glazing unit and method of making same” {which also relates to U.S. Pat. Nos. 5,501,013 and 5,351,451}; and U.S. Pat. No. 6,223,414 entitled “Method of making an insulating unit having a low thermal conducting spacer.”

Tremco is the assignee of U.S. Pat. No. RE 35,291 entitled “Apparatus for laying strip on glass or like material”; U.S. Pat. No. 5,045,146 entitled “Tape applicator with corner forming device”; and U.S. Pat. No. 5,013,377 entitled “Apparatus for laying strip on glass or like material.”

Weather Shield Mfg is the assignee of U.S. Pat. No. 5,640,828 entitled “Spacer for an insulated window panel assembly.”

The aforementioned patents are incorporated herein by reference and disclose the details of IGU fabrication, sealant and spacer construction, sealant application head construction.

The above identified patents and patent publications are representative for the state of the art and are incorporated herein by reference. These references, taken collectively in connection with the general knowledge in the art further establish there remains a need in the art for a cost effective, easily manufactured IGU spacer with superior operational properties.

### SUMMARY OF THE INVENTION

One aspect of the present invention provides a spacer with a hollow interior in which a series of holes or notches are present on a back surface thereof to assist in desiccant filling, wherein the holes are sealed with a sealant such as, in one example, a metallic tape extending or wrapping around the entire perimeter of the spacer. This design allows the spacer to be easily filled with desiccant matrix and can allow for the filling process to be accomplished, in situ. “In situ” in this context means at or on the IG assembly line.

One aspect of the present invention provides a flexible spacer with a hollow interior which is sufficiently flexible as to be supplied in coil form to an IG assembly line. The flexibility can be provided to the spacer through the construction of a thin-walled profile, a plurality of kerfs or notches across the back of the spacer frame into the sides, a plurality of kerfs or notches across the front of the spacer frame into the sides, a plurality of kerfs or notches across the opposed sides of the spacer frame, and mixtures and combinations of these design features. The flexibility of the spacer can also more easily allow for the in situ assembly of the final spacer. Again, “in situ” in this context means at or on the IG assembly line.

One aspect of the present invention provides an apparatus for wrapping a spacer frame with a flexible one piece free film entirely around the perimeter of the spacer frame. The apparatus for wrapping of the spacer frame can also more easily allow for the in situ assembly of the final spacer. Again, “in situ” in this context means at or on the IG assembly line.

One detailed aspect of this invention provides a flexible spacer for an insulated glass unit including a one piece flexible spacer frame forming a pluralities of corners and a plurality of straight lineal portions, wherein the straight lineal portions define straight sides of the spacer, each lineal portion having at least a pair of spaced sides and a back extending between the sides wherein the back and pair of sides of each straight lineal portion define a hollow interior, wherein each side is configured to be positioned adjacent a lite of an insulated glass unit; a desiccant material within at least a part of the hollow interior of at least one lineal portion; and a one piece free film adhesively coupled to the lineal portions, wherein the one piece film is covering the entire outer facing surface of the back of each lineal portion and is completely encircling the outer facing outer perimeter of the flexible spacer frame.

Another detailed aspect of the invention provides a spacer for an insulated glass unit including a one piece spacer frame forming a pluralities of corners and a plurality of straight lineal portions, wherein the straight lineal portions define straight sides of the spacer, each lineal portion having at least a pair of spaced sides and a front and a back extending between the sides wherein the front, the back and pair of sides of each straight lineal portion define a hollow interior, wherein each side is configured to be positioned adjacent a lite of an insulated glass unit, and further including openings through the back of each lineal extending to the hollow interior, wherein the openings are in the form of a plurality of parallel spaced notches with each notch extending entirely across the back and into the sides of the lineal; and a desiccant material within at least a part of the hollow interior of at least one lineal portion.

One aspect of the invention is directed to an insulated glass unit incorporating a spacer in accordance with the present invention.

One detailed aspect of this invention is directed to a spacer for an insulated glass unit comprising a plurality of straight lineal portions defining straight sides of the spacer, each lineal portion having at least a pair of spaced sides and a back extending between the sides wherein the back and pair of sides of each straight lineal portion define a hollow interior, wherein each side is configured to be positioned adjacent a lite of an insulated glass unit; at least one key coupling member, each key coupling member attaching two adjacent lineal portions together; desiccant material within at least a part of the hollow interior of at least one lineal portion; and a one piece free film adhesively coupled to the lineal portions, wherein the one piece film is covering the entire outer facing surface of the back of each lineal portion and is completely encircling the outer facing outer perimeter of the lineal portions. A “free film” is a film layer (or plural) that does not require a separate substrate for support, and such films may be provided in their own roll for assembly.

The spacer for an insulated glass unit of the present invention may be constructed wherein the one piece free film covers at least a portion or the entirety of the outer facing surface of each of the sides of each lineal. The spacer for an insulated glass unit of the present invention may be constructed wherein the one piece free film is a metalized film with an adhesive. The film may also be a polyester film, such as the Mylar® brand films.

The spacer for an insulated glass unit of the present invention may be constructed wherein the key coupling members are corner coupling members and four corner key coupling members are provided. Alternatively the straight lineal members may be connected by formed corners, and two, or more, straight lineal portions are coupled with a straight coupling key.

The spacer for an insulated glass unit of the present invention may be constructed wherein the one piece free film overlaps itself on one lineal portion. Additionally the spacer for an insulated glass unit of the present invention may be constructed wherein one back of at least one lineal includes openings there through extending to the hollow interior. Further the spacer for an insulated glass unit of the present invention may be constructed wherein each lineal includes a front extending between the sides at an interior end thereof.

The present invention provides an insulated glass unit comprising: a plurality if lites, each lite spaced from an adjacent lite by a gap; a spacer between each adjacent pair of lites and coupled to the lites, each spacer including i) A plurality of straight lineal portions defining straight sides of the spacer, each lineal portion having at least a pair of spaced sides and a back extending between the sides wherein the back and pair of sides of each straight lineal portion define a hollow interior, wherein each side is configured to be positioned adjacent a lite of an insulated glass unit, ii) At least one key coupling member, each key coupling member attaching two adjacent lineal portions together; iii) Desiccant material within at least a part of the hollow interior of at least one lineal portion; and iv) A one piece free film adhesively coupled to the lineal portions, wherein the one piece film is covering the entire outer facing surface of the back of each lineal portion and is completely encircling the outer facing outer perimeter of the lineal portions and covering at least a portion of each side of each lineal; and the insulating glass unit further including a primary seal between the one piece free film along each side of the lineal and one adjacent lit, wherein the primary seal extends the entire perimeter of the spacer. The insulated glass unit of the present invention may be constructed to further include a secondary seal extending between the lites and the one piece film along the back of each lineal.

Another aspect of the invention provides a system for manufacturing a wrapped spacer for insulating glass units comprising: a station for assembling a plurality of straight lineal portions defining straight sides of the spacer, each lineal portion having at least a pair of spaced sides and a back extending between the sides wherein the back and pair of sides of each straight lineal portion define a hollow interior, wherein each side is configured to be positioned adjacent a lite of an insulated glass unit with at least one key coupling member, each key coupling member attaching two adjacent lineal portions together; a station for introducing desiccant material within at least a part of the hollow interior of at least one lineal portion; and a wrapping station for attaching a one piece free film adhesively coupled to the lineal portions, wherein the one piece film covers the entire outer facing surface of the back of each lineal portion and is completely encircling the outer facing outer perimeter of the lineal portions and covering at least a portion of each side of each lineal.

The features that characterize the present invention are pointed out with particularity in the claims which are part of this disclosure. These and other features of the invention, its operating advantages and the specific objects obtained by its use will be more fully understood from the following detailed description in connection with the attached figures.

### BRIEF DESCRIPTION OF THE FIGURES

FIGS. 1A-1E are schematic perspective views of partially assembled wrapped spacers for insulated glass units according to various aspects of the present invention;

FIG. 1F is a schematic perspective view of partially assembled spacer having intermittent corner notching for insulated glass units according to various aspects of the present invention;

FIG. 1G is a schematic perspective view of spacer of FIG. 1F prior to corner formation;

FIGS. 2A-E are schematic section views of the insulated glass units in accordance with the present invention;

FIGS. 3A-B are schematic side and perspective views, respectively, of a corner key coupling member for forming the spacer frame of the spacer of the present invention;

FIGS. 3C-D are schematic side and perspective views, respectively, of a straight key coupling member for forming the spacer frame of the spacer of the present invention; and

FIG. 4 is an exploded view of a spacer frame construction of one spacer frame of one spacer according to the present invention.

FIG. 5A is a schematic side elevation view of a lineal portion of a notched spacer frame made in accordance with one embodiment of the present invention;

FIG. 5B is a schematic perspective view of a coiled configuration of a flexible spacer frame of FIG. 5A;

FIG. 5C is a schematic perspective view of a coiled configuration of a flexible spacer frame of an alternative embodiment of the present invention;

FIGS. 6A-C are schematic views of the manufacturing of a spacer in accordance with one aspect of the present invention using the flexible spacer frame of FIGS. 5A and 5B;

FIG. 6D is a schematic view of the manufacturing line for a spacer in accordance with FIGS. 1F-G;

FIG. 7 is a schematic top plan view of an insulated glass unit with an upper pane removed in accordance with one aspect of the invention using the spacer formed in FIGS. 6A-6C;

FIG. 8 is a schematic top plan view of an insulated glass unit with an upper pane removed in accordance with another aspect of the invention;

FIG. 9A is a schematic perspective view of a spacer frame in accordance with the present invention having back and side notches or kerfs;

FIG. 9B is a schematic perspective view of a notched or strip used to form the spacer frame of FIG. 9A;

FIG. 10A is a schematic perspective view of a spacer frame in accordance with the present invention having opposed side notches or kerfs;

FIG. 10B is a schematic perspective view of a notched or strip used to form the spacer frame of FIG. 10A;

FIG. 11A is a schematic plan view of a spacer frame in accordance with another aspect of the present invention;

FIG. 11B is a schematic perspective view of the spacer frame of FIG. 11A;

FIG. 12A is a schematic plan view of a spacer frame in accordance with another aspect of the present invention;

FIG. 12B is a schematic perspective view of the spacer frame of FIG. 12A;

FIG. 13A is a schematic side view of a spacer frame in accordance with another aspect of the present invention;

FIG. 13B is a schematic side view of the spacer frame of FIG. 13A with a formed corner; and

FIG. 14 is a schematic partially sectioned view of a spacer according to one aspect of the present invention.

### DESCRIPTION OF THE PREFERRED EMBODIMENTS

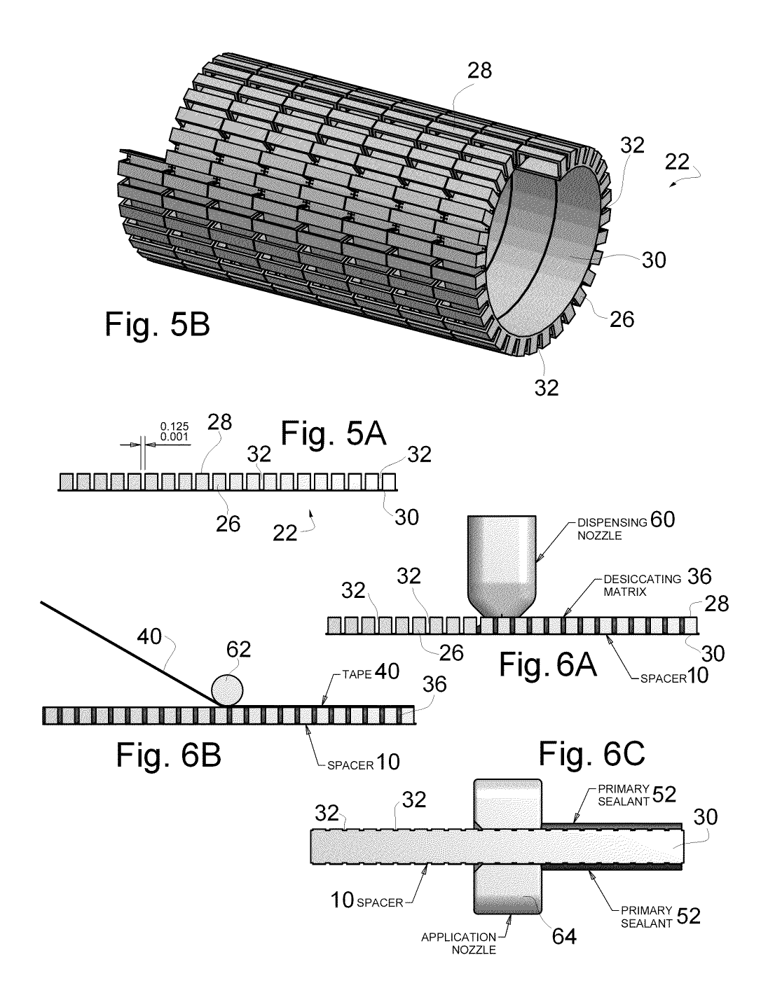

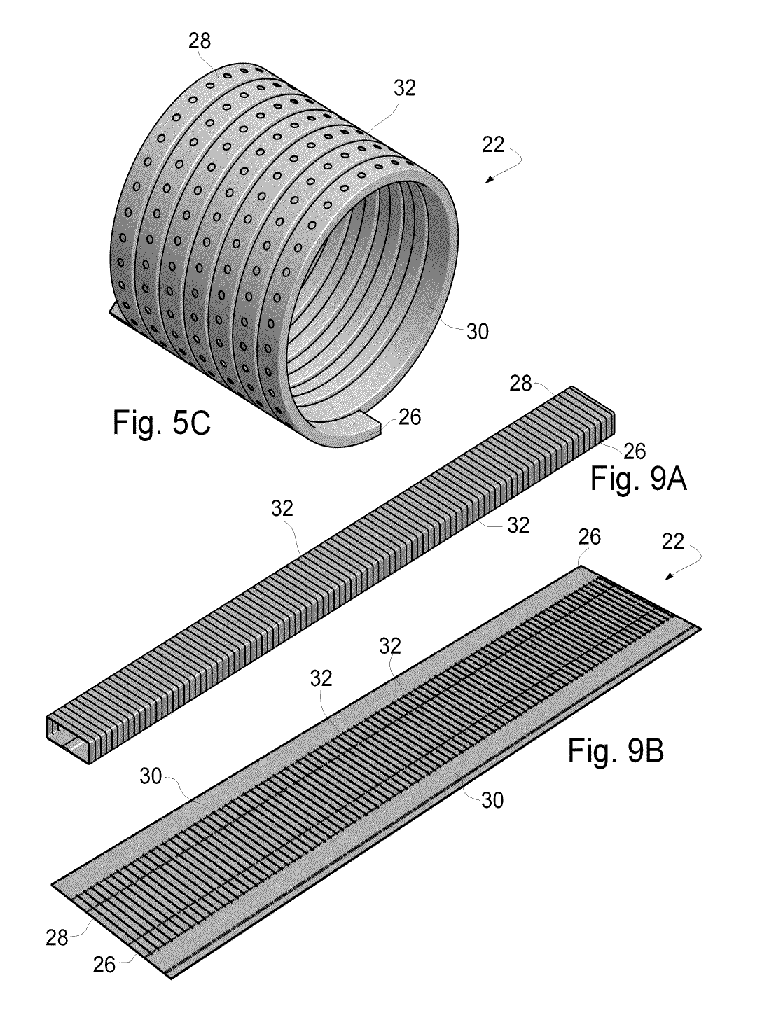

Prior to discussing the details of the present invention, as an overview, one key aspect of the present invention provides a spacer 10 with a hollow interior 34 in which a series of holes 32, such as notches or kerfs, are present on a back surface 28 thereof to assist in desiccant filling, wherein the holes are sealed with a sealant such as, in one example, a flexible one piece free film 40 extending or wrapping around the entire perimeter of the spacer frame. This design allows the spacer 10 to be easily filled with desiccant matrix 36 and can allow for the filling process to be accomplished, in situ. Another key aspect of the present invention provides a flexible spacer 10 with a hollow interior 34 which is sufficiently flexible as to be supplied in coil form as represented in FIGS. 5B and 5C to an IG assembly line. The flexibility can be provided to the spacer 10 through the construction of a thin-walled profile, a plurality of kerfs or notches 32 across the back 28 of the spacer frame into the sides 26, a plurality of kerfs or notches 32 across the front 30 of the spacer frame into the sides 26, a plurality of kerfs or notches across the opposed sides 26 of the spacer frame, and mixtures and combinations of these design features as well as intermittent kerfing or notching at the corner portions. The flexibility of the spacer can also more easily allow for the in situ assembly of the final spacer. A further key aspect of the present invention provides an apparatus for wrapping a spacer frame 10 with a flexible one piece free film 40 entirely around the perimeter of the spacer frame. The apparatus for wrapping of the spacer frame can also more easily allow for the in situ assembly of the final spacer. “In situ” in this context means at or on the IG assembly line.

Wrapped Spacer 10

The present invention, in one aspect, includes a spacer 10, formed as a wrapped spacer 10 as described hereinafter, for an insulated glass unit 20. The spacer 10 includes a spacer frame formed of a plurality of straight lineal portions 22 defining straight sides of the spacer 10 in the embodiments shown. The lineal portions 22 can also be referred to as lineals, lineal members, lineal components, lineal spacer frame members and may be formed of a metal, such as aluminum, stainless steel or an appropriate alloy. The shape may be extruded or rolled from strip material. The spacer frame lineal portions 22 may be formed from plastic as well, through an extrusion process, although other molding techniques could be applicable.

The vast majority of IGUs 20 use straight sides formed by lineal portions 22 as shown, but curved edges for rounded or even circular ICU's 20 are also known. The flexible spacer frames discussed below are well adapted for forming such curved sections, and thus the lineal portions 22 of the spacers 10 of the present invention are not limited to “straight sections” unless identified as “straight” lineal portions.

As shown in the figures, notably FIG. 4, the spacer frame may have a plurality of separate straight rigid lineal portions 22 for each side of the spacer frame, most commonly in the form of a rectangle, wherein corner coupling key members 24 couple each adjacent side forming straight lineal portion 22. In some configurations there is no bending of the elements forming the straight lineal portions 22 which can thus be easily formed or cut to length. The present disclosure contemplates and teaches embodiments of the spacer 10 having “rigid” spacer frame lineal portions 22, and “flexible” spacer frame lineal portions 22, and “adjustable” spacer frame lineal portions 22 which are discussed separately hereinafter.

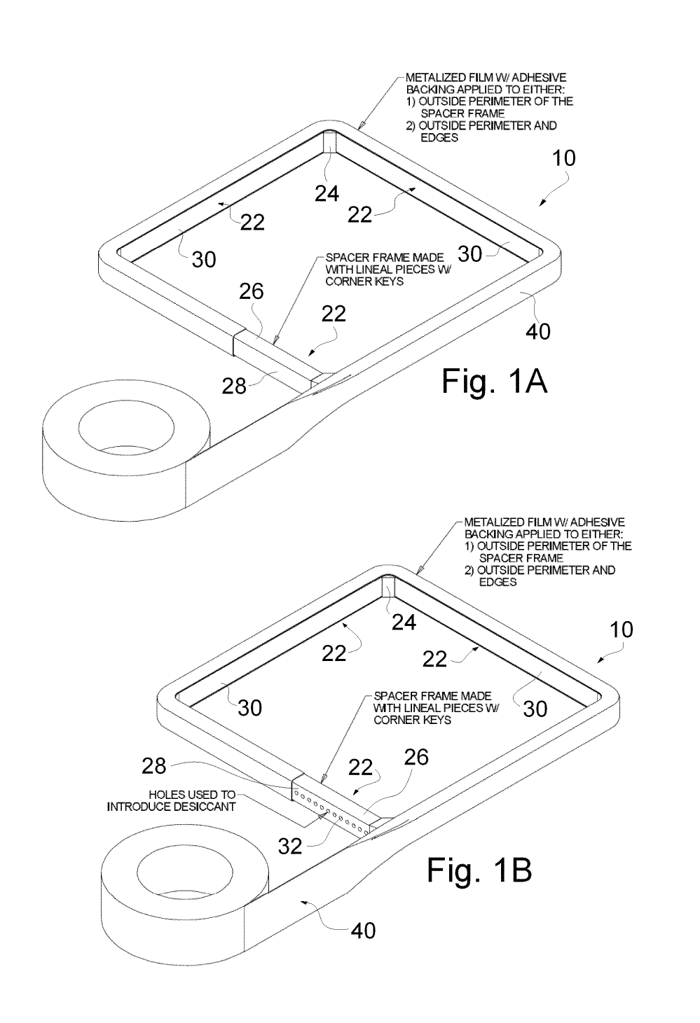

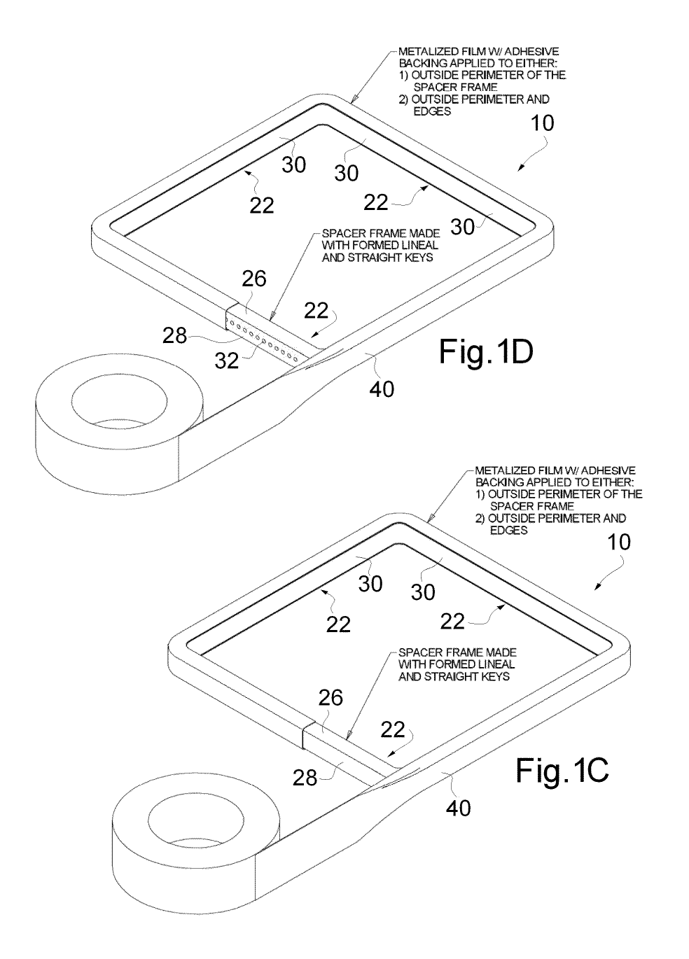

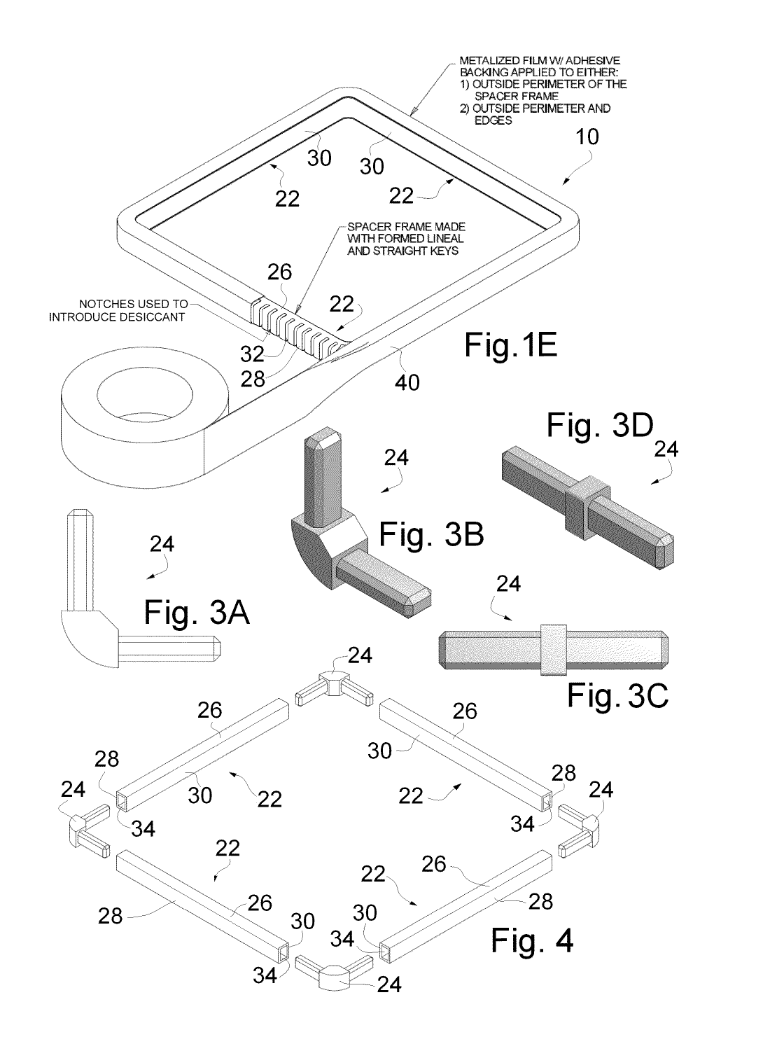

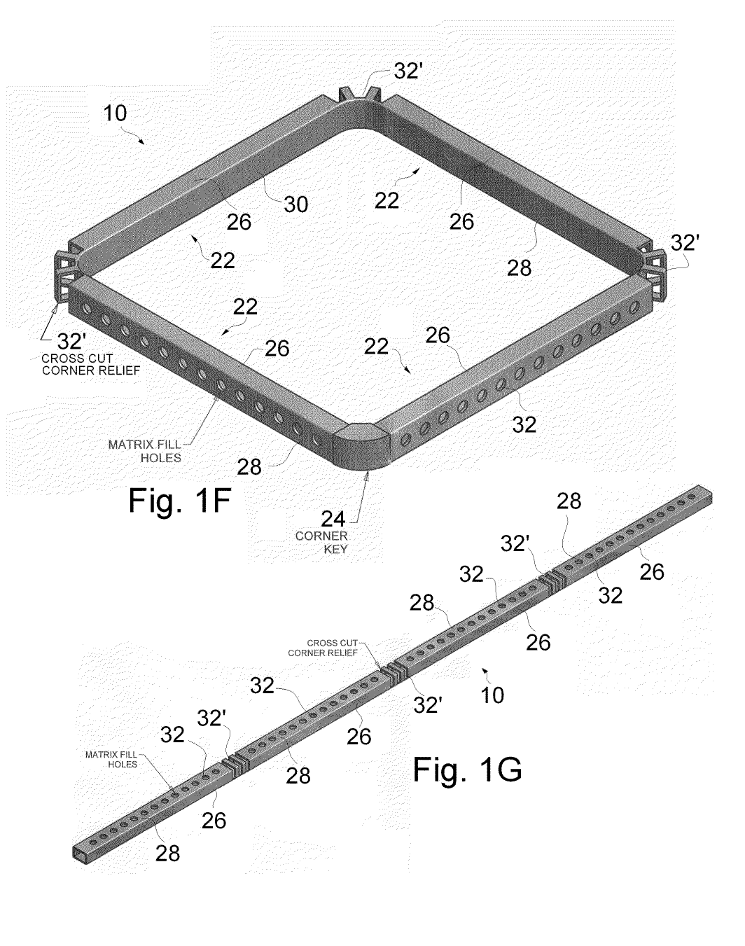

Alternatively, the spacer frame, as shown in the embodiments of FIGS. 1C-F, may be formed of, generally, a single structural member forming the straight lineal portions 22 and having bent or flexed corners, wherein at least one side of the spacer frame is formed of two aligned lineal portions 22 connected by a straight coupling key member 24, or one corner uses a corner key as shown in FIG. 1F. In these configurations the spacer frame has less coupling joints, namely generally only a single key member 24, than is found in the configuration using multiple corner coupling key members 24 such as FIG. 4 and FIGS. 1A and B. Further alternative spacer frame constructions are possible, such as multiple straight coupling key members 24 or combinations of corner coupling key members 24 and straight coupling key members 24, but these alternatives seem generally less desirable from a manufacturing position.

In the spacer frame, each lineal portion 22 has at least a pair of spaced sides 26 and a back 28 extending between the sides 26. The back 28 and pair of sides 26 of each straight lineal portion 22 define a hollow interior 34. As shown in the figures, each side 26 is configured to be positioned adjacent a lite 50 of an insulated glass unit 20. The back 28 of the spacer frame in this application references the surface of the spacer frame facing away from the interior air gap between the lites 50. The lite 50 is typically a glass pane of conventional construction, but other materials are known as well has a large number of coatings on the substrate. Each lineal portion 22 can further include a front 30 forming a rectangular member in cross section as shown. The front 30 of a spacer frame within the meaning of this application is the surface facing the interior gap of the IGU which may be under a partial vacuum and may be filled with selected gasses for increased thermal properties.

As noted above the spacer frame of the above described embodiments include at least one key coupling member 24, wherein each key coupling member 24 is attaching two adjacent lineal portions 22 together. The key coupling members 24 shown in the figures are corner key coupling members 24, shown individually in FIGS. 3A and B, which form a ninety degree bend between the coupled lineal portions 22 or a straight key coupling member 24, shown individually in FIGS. 3C and D, which aligns with the adjacent lineal portions 22 being coupled. The structure and operation of coupling key members, such as members 24, in general is well known in the art. The members 24 are generally formed out of plastic, such as by injection molding, and include legs that are press fit into the interior of adjacent lineal portions 22. The angle of the legs, relative to each other, define whether the member is a corner or straight coupling member 24, and the legs will be set to align with the associated attached lineal portion 22 into which the leg is inserted, Adhesive can be used to assist such coupling. Angles other than ninety (corner) and one hundred eighty (straight) could also be used to form the members 24, such as for forming a non-rectangular window, however these two configurations for members 24 shown are, by far, the most common.

The coupling members 24 (or single member 24) form a joint in the spacer frame that must include additional sealing as described below. The spacer frame of the invention in the above described embodiments includes at least one such joint.

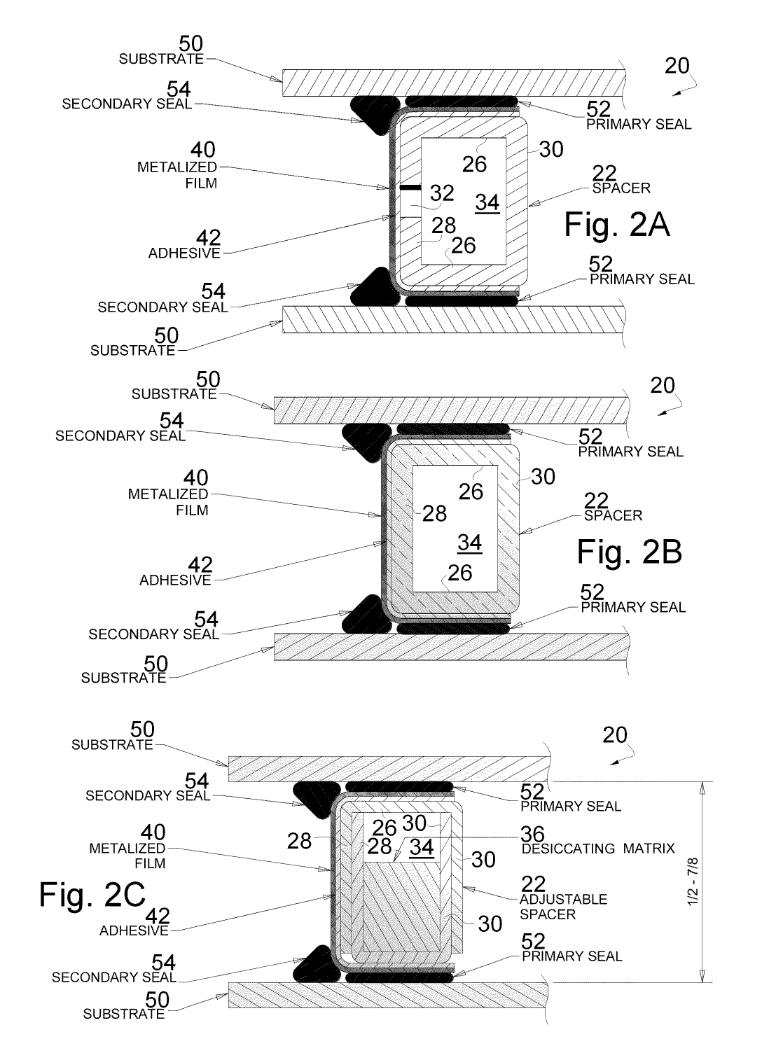

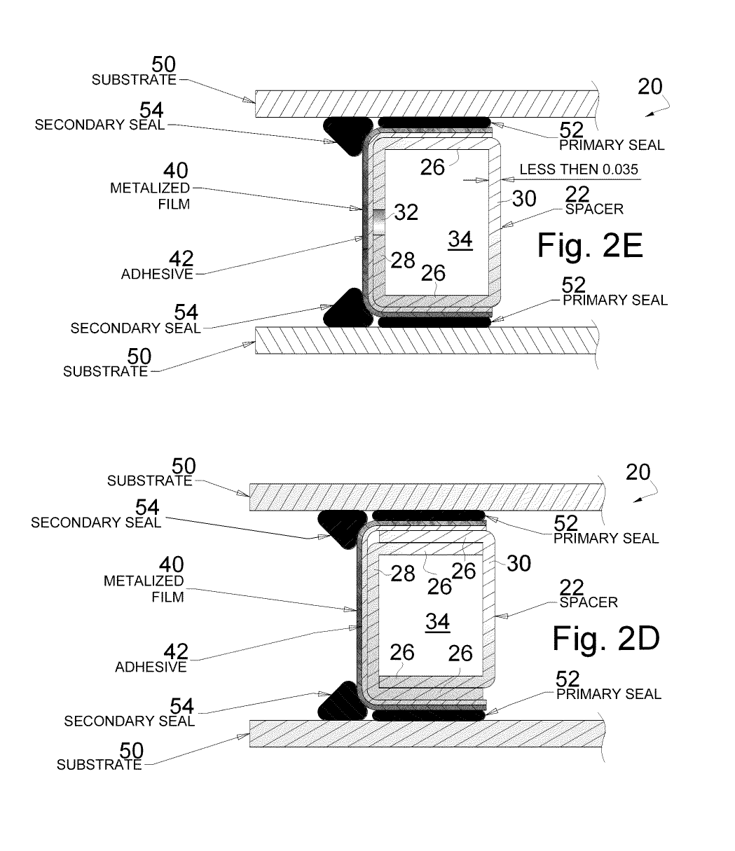

Desiccant material 36 is provided within at least a part of the hollow interior 34 of at least one lineal portion 22 of the spacer frame, as represented in FIG. 2C. Desiccant material 36 is well known in the art and can be referenced as a desiccant matrix. A desiccant matrix 36 includes a particular desiccant material or combination of such known materials generally together with a carrier or binder material, such as an inert organic binder. Known particular desiccant materials include, but are not limited to, silica gels, activated carbons, silica alumina, calcium sulfate, calcium oxide, natural zeolites and molecular sieves and the mixtures thereof. The binder can form the desiccant matrix into a “hot melt” desiccant matrix 36 for ease of application, such as described in U.S. Pat. Nos. 5,177,916; 5,510,416; 5,509,984; 6,112,477; 6,180,708; and in U.S. Patent Publication 2009-0069170, all of which are incorporated herein by reference.

The lineal portion 22 may be provided with openings 32 in the back 28 that communicate with the interior 34 to assist in filling the interior with desiccant material 36. The desiccant matrix 36 may be injected into the interior 34 through several spaced locations through several openings 32 along the lineal portion 22, and may be a thermo settable material, or flow-able beads.

The front 30 of the lineal portions 22 having the desiccant material 36 therein in space 34 may include openings (not shown) to communicate with the space between the lites 50 to facilitate, if desired, the operation of the desiccant material 36 on the space between the lites 50. There is some discussion in the art whether such openings from the desiccant material containing interior 34 into the space between the lites 50 is aesthetically desirable or if it actually improves the function or operation of the desiccant material 36. Consequently, such openings in the front 30 may, or may not, be provided as desired by the end user without effecting the details of the invention in the embodiments described above.

The spacer 10 in the embodiments described above, includes a one piece free film 40 coupled to the lineal portions 22 with an adhesive layer 42. The film 40 is a “free film” in that it does not require a separate substrate, such as the spacer frame, for support. The film 40 and the adhesive layer or backing 42 is provided in their own roll, as shown in the FIGS. 1A-E, for assembly of the spacer 10, which can be in situ at the IGU assembly line. The adhesive layer can be, for example, an acrylic adhesive or a polyisolbutalene (FIB) which is a gas impermeable material. The one piece film 40 is covering the entire outer facing surface of the back 28 of each lineal portion 22 and covering each joint such as formed by each coupling member 24. The one piece film 40 is completely encircling the outer facing outer perimeter (i.e. the backs 28) of the lineal portions 22.

The one piece free film 40 may cover only the back portion 28, or alternatively the film 40 may cover at least a portion of the outer facing surface of each of the sides 26 of each lineal portion 22. As shown in the figures in the embodiments described above, the free film 40 may cover the entire outer facing surface of each side 26 of each lineal portion 22. The one piece free film 40 may be a metalized film with an adhesive 42 (also called a foil film or metallic tape), or it may be a polyester film, such as MYLAR® brand films or what is called a metalized MYLAR® brand film. The one piece free film 40 preferably overlaps itself (not shown in the assembly drawings) on one lineal portion 22 for a small segment (generally one to two inches) to assure hermetic sealing of the spacer 10. The film 40 with adhesive 42 forms a complete seal and uniform sealing or coupling surface for the spacer 10. The film 40 has some elongation or stretchable characteristics to allow the corner formation (whether the corner is bent or it is a flexible spacer frame). The adhesive 42 is one, very efficient, method of attaching the film 40, as an alternative the film 40 may be a thin metallic sheet welded into place without adhesive. Alternatively other films could be implemented that utilize thermal bonding without a separate adhesive layer, however the adhesive 42 backed film 40 is preferred.

Insulated Glass Unit 20

The spacer 10 of the invention is used in an insulated glass unit 20 as shown in FIGS. 2A-E. Each insulated glass unit 20 includes a plurality of lites 50, each lite 50 spaced from an adjacent lite 50 by a gap, often called an air gap. Two lites 50 will be provided in a double glazed unit for IGU 20 while three lites 50 are provided in a triple glazed unit. Higher numbers of lites 50 are also possible; however two and three lite IGUs are likely to be the most common desired configurations. The figures illustrate double glazed unit construction.

A spacer 10, formed in the manner described above, is provided between each adjacent pair of lites 50 in the IGU 20 and is coupled to the lites 50. A primary seal 52 is provided between the one piece free film 40 along each side 26 of each of the lineal portions 22 and one adjacent lite 50, wherein the primary seal 52 extends the entire perimeter of the spacer 10. The film 40 provides a uniform, effective sealing surface to couple to the lite 50. The primary seal 52 may be a conventional sealant. However the present invention allows for alternative sealants to be considered as the primary seal 52 need only be between the part of the film 40 on the side 26 and the lite 50. In the embodiment described above in which the film 40 is only on the back 28 or only partially covering the outer facing surface of the side 26, the primary seal 52 will couple directly to the side 26 and extend to the film 40. The primary seal 52 is not a “free film” as is the free film 40 as the seal 52 at application requires the underlying members for its integrity.

A secondary seal 54 is provided between the lites 50 and the portion of the film 40 along the back of each lineal 22 as shown. The secondary sealant may be conventional sealant, but need not be provided across the entire back as in prior applications of such sealants, as the film 40 is sealing the spacer 10. This can result in a savings of material. In view of the change in the primary function of the sealants, the present IGU 20 can use different sealants than typically employed in the prior art for similar primary and secondary seals. For example, silicon and polysulfide or polyurethanes can be used and such sealants can be used in lesser total amounts in the units 20 because the spacer 10 utilizes the fully wrapped film 40.

System for Manufacturing a Wrapped Spacer 10

The present invention contemplates a system for manufacturing a wrapped spacer 10 in accordance with the above discussion for use in assembling insulating glass units 20 as described above.

In the manufacture of a spacer 10 with rigid lineal portions 22 the system will include a station for assembling (the assembly station) a plurality of straight lineal portions 22 defining straight sides of the spacer 10. As noted above each lineal portion 22 having at least a pair of spaced sides 26 and a back 28 extending between the sides 26 wherein the back 28 and pair of sides 26 of each straight lineal portion 22 define a hollow interior 34. As noted above, each side 26 is configured to be positioned adjacent a lite 50 of an insulated glass unit 20 with at least one key coupling member 24, each key coupling member 24 attaching two adjacent lineal portions 22 together.

For the four corner coupling member 24 spacer frame of FIG. 4, the assembly station may include a station severing lineal portions 24 from longer feed stock of such elements to the desired lengths of lineal portions to provide these components of the spacer frame. For the spacer frame utilizing bent corners, the assembly station includes a severing station for severing a component generally the length of the circumference or perimeter of the spacer frame together with a bending unit for forming the bent corners. The general construction of a device severing stock material into desired lengths is something well known to those of ordinary skill in the art as is a conventional bending unit (which may include mechanism for notching metal components to allow for bending as well as bending rolls or forms).

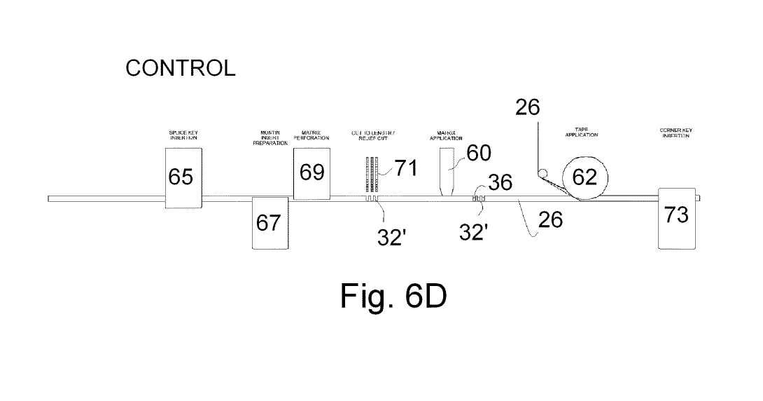

The system will include a station, the desiccant station schematically shown in FIG. 6A for a “flexible spacer frame”, for introducing desiccant material 36 within at least a part of the hollow interior 34 of at least one lineal portion 22. The desiccant station may include a system for providing holes 32 into the backs 28 of some or all lineal portions if they are not earlier provided.

FIGS. 1E and 5A and 5B illustrate an embodiment in which notches or kerfs are provided through back 28 extending across the back 28 through the entire sides 26 forming the desiccant introducing holes 32, and in this construction the notches provide flexibility to the structure in one direction for forming bent or flexed corners (while the structure maintains rigidity in the opposite direction and in the direction of the gap). Where the holes 32 (i.e. notches) are provided to assist in forming bent or flexed corners, the holes 32 are provided in the component at or before the assembly station. The notch embodiment of FIG. 1E is also well suited for forming the lineal portions from a plastic member. The desiccant material or matrix 36 is introduced into the interior 34 typically through a heated injection nozzle 60 using a thermosetting matrix at a plurality of locations along the back 28. Other application techniques could be implemented. The dispersing of a desiccant matrix 36 into the interior 34 of a lineal 22 itself, is believed to be well known to those of ordinary skill in the art, however the plurality of spaced holes 32 along the back 28 significantly improve or simplify the application process.

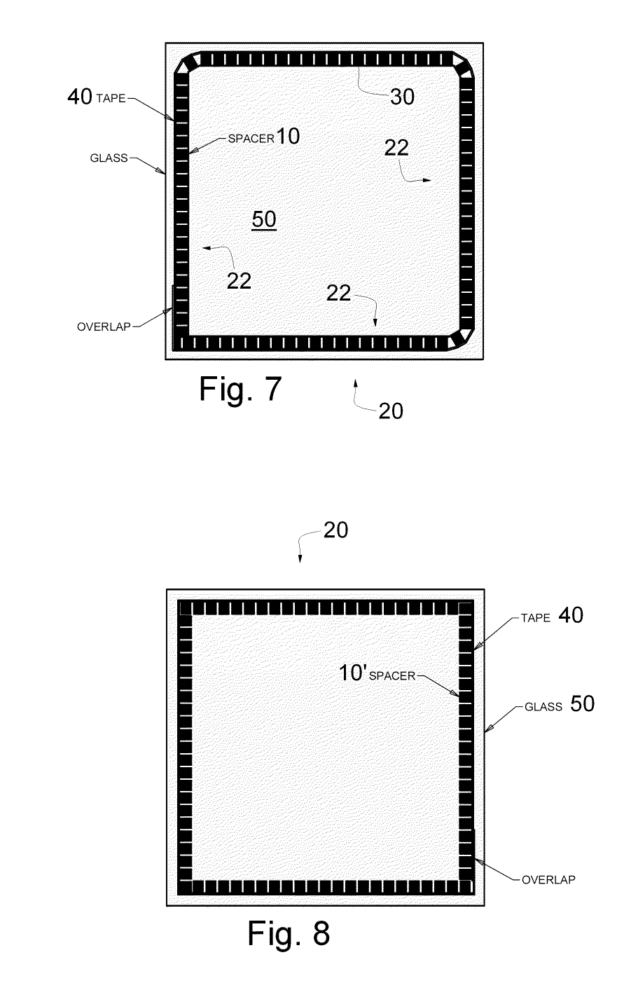

The system will include a wrapping station, shown in FIG. 6B schematically, for attaching a one piece free film 40 adhesively (via adhesive layer 42) coupled to the lineal portions 22, wherein the one piece film 40 covers the entire outer facing surface of the back 28 of each lineal portion 22 forming the spacer frame and is completely encircling the outer facing outer perimeter of the lineal portions 22 of the spacer frame. Further the film 40 may be covering at least a portion of, or the entire, outer facing surface of each side 26 of each lineal portion 22 as shown. The wrapping station will effectively dispense the film 40 from a roll, as schematically shown, which will be pressed onto the back 28 and possibly sides 26 of the lineal portions 22 with forming rollers 62. The present invention contemplates a one to two inch overlap of the film 40 (shown in FIGS. 7 and 8, schematically). The wrapping station will sever the roll at the appropriate location. The structure of such a wrapping station, in general as described herein, is believed to be known to those of ordinary skill in the art.

After the spacer 10, per se, is formed, the sealant 52 will be applied such as through nozzles 64, schematically shown in FIG. 6C for reference, or the like before the spacer 10 is attached to a lite 50 of an IGU. The secondary seals 54 are applied to the combined lites 50 and spacer 10 after these have been partially assembled, through the use of appropriate dispensing nozzles.

Rigid Spacer 10

The spacers 10 of the present invention as illustrated show examples of what is termed rigid and flexible spacers 10. All of the spacers 10 of the invention provide a substantially rigid support in the dimension of the gap between the lites 50, as opposed to foam spacers of the prior art. Within the meaning of this application a spacer frame will have a rigid structure in the gap dimension and this is found in all the designs of the present invention.

Further, the spacer 10 embodiments of FIGS. 1A-1D represent “rigid” spacers. Within the meaning of this application a rigid spacer 10 presents a rigid structure in the dimensions parallel to the gap of the IGU and thus requires a plastic deformation of the spacer frame material, or use of a corner key to form a corner. A plastically deformed corner is referenced as a bent corner and generally requires a bending unit or other mechanism to bend and form the corner. The film 40 is stretchable for bent corners or for flexed corners and is not considered when classifying a spacer frame as a rigid or flexible member.

FIG. 1E illustrates a flexible or a rigid spacer 10 that is dependent upon the formation of the notches or kerfs forming the openings 32. Within the meaning of this application a notch or a kerf defines a hole 32 extending entirely across one surface of the spacer frame, such as across the back 28. As shown the openings 32 in the embodiment of FIG. 1E are formed by a plurality of parallel notches extending entirely across the back 28 and into the sides 26. If these notches 32 extend only partly into the depth of the sides 26 the resulting spacer frame can be a rigid spacer. However, if they extend the entire depth of the sides 26 the spacer frame can be flexible.

Even in a “rigid” spacer 10 with notches forming openings 32, the presence of the notches extending across the entire back 28 and into the sides 26 will make it easier to bend (deform) the spacer frame at the corners to form the spacer.

Flexible Spacer 10

Within the meaning of this application a flexible spacer 10 requires no plastic deformation of the material to form a corner. FIG. 1E, FIG. 1F, FIGS. 5A-C, and 5B, FIG. 7, FIGS. 9-12 and 14 illustrate examples of flexible spacers 10. A significant advantage of flexible spacers 10 is in the assembly process because the flexible spacer frames (noted by the designation of lineal 22 in FIGS. 5A and 5B) can be supplied to an assembly line in a coil form such as illustrated in FIGS. 5B and 5C. Further after the flexible spacer 10 is formed it need only be applied to the lite 50 as shown in FIG. 7, similar to a prior art foam spacer.

Notched Spacer 10

As noted above the notches forming the openings 32 are one method of making a spacer frame flexible within the meaning of this application. The notches may be formed after the spacer frame is formed into a hollow tube shape with cutting blades or the like. Alternatively, the spacer frame can be formed from a strip as shown in FIG. 9B with the notches 32 formed prior to forming of the strip with bending rolls into the spacer frame shown in FIG. 9A. This illustrates an easy method of forming the notches and allows for in situ spacer manufacturing.

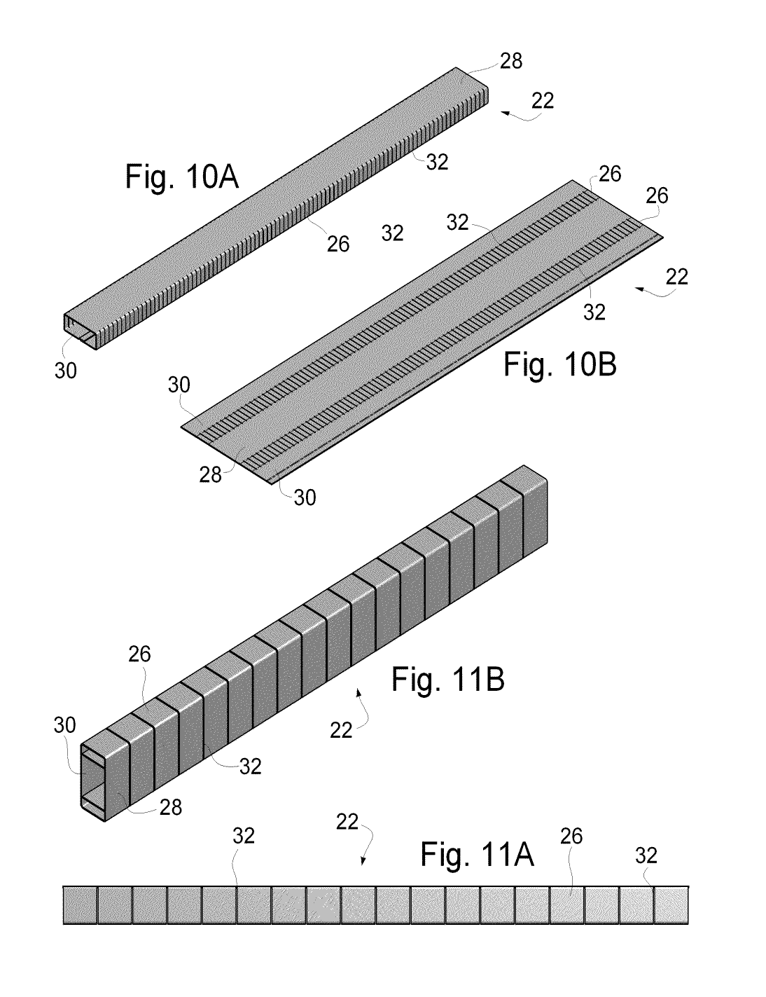

FIGS. 10A and B illustrate an alternative embodiment in which the notches 32 are formed in the opposed sides 26 rather than the back 28 to allow for the flexibility to the spacer frame. FIG. 10B illustrates how such a spacer frame can be formed from a strip in which it may be easier to cut the notches 32. In this embodiment the desiccant would be introduced through the sides 26 of the spacer frame.

FIGS. 11A and B illustrate an embodiment of the present invention in which the spacer frame is made flexible with notches 32 in the back 28 and sides 26. The difference in this embodiment is that the interior 34 is formed of separate longitudinal channels. This embodiment allows the desiccant matrix to be selectively placed in selected channels within the interior 34 if that provides advantage to the IGU design. The dividers forming the separate channels would also have the notches extending there through to allow for flexibility to the spacer frame.

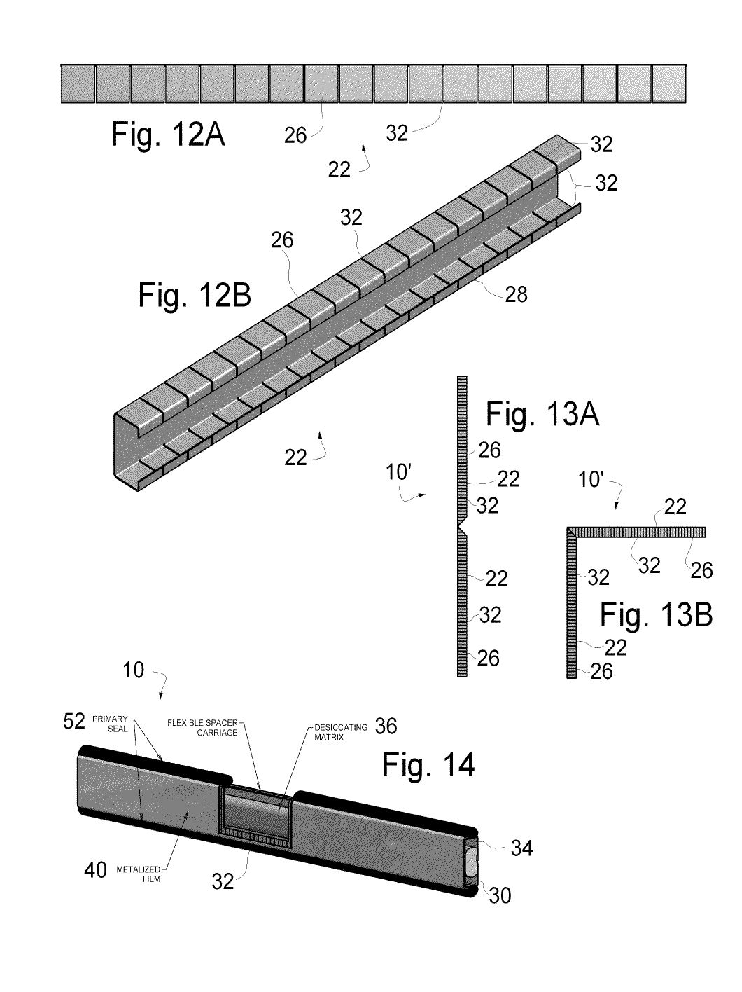

FIGS. 12A and B illustrate an embodiment of the present invention in which the spacer frame is made flexible with notches 32 in the back 28 and sides 26. The difference in this embodiment is that the back 28 has a longitudinal slot (which is considered as part of the openings 32 for this applications) to facilitate the placement of the desiccant 36. In the back 28 it is considered that the separate openings 32 are not separated from each other thereby forming a continuous slot in this dimension as shown. The openings 32 are continued as notches across the front 28 and into the sides 26 as shown to allow for the flexibility. The embodiment of FIGS. 12A and B (a C-Channel structure) can be used without the notches (just the slot 32) where rigid straight lineal portions are desired. With this C-Channel shape (with or without the notches) the film 40 still seals the back 28 as in the earlier embodiments.

Intermitted Notched Spacer 10

An alternative spacer 10 is shown in FIGS. 1F and 1G which uses matrix fill holes 32 as discussed above and intermittent notches 32′ only at some of the corners to provide the flexibility for forming at least some of the corners. The notching 32′ could also be used to form curved lineal portions with ease as well. The corner notches 32′ may be formed on three corner positions and the remaining corner are formed as a corner key 24 as shown in FIG. 1F. Alternatively four sets of corner forming notches 32′ can be used and a straight coupling key 24 used to assemble the rectangular spacer. It should be apparent that other shapes can be easily formed as desired, such as pentagram, octagonal, trapezoidal, semicircular and the like. The spacer 10 will be covered with tape (not shown in FIG. 1F for clarity) as noted above.

The spacer 10 of FIGS. 1F and G can be formed with the line shown in FIG. 6D. The line can be fed with straight frame members that are keyed together with straight keys at key insertion station 65. The figure also shows a muntin insert preparation station 67 to illustrate that other processes may be performed in the preparation of the spacer 10 during assembly. Following station 67 is a perforation device or station 69 for forming the fill holes 32 which are for filing each segment with matrix 36. Following the station 69 is a notch cutting station and cut to length station 71. This is used for forming the notches 32′ intermittently along the length at the designated corners or bends of the spacer frame (except for at the corner with key 24). The intermittent corner notch design allows for flexibility to be provided at the corners while maintaining greater structure in the lineal portions as shown. The station 71 will also cut the spacer to length as appropriate. The spacer will be filled with matrix 36 at station 60 and sealed with tape at station 62 then a corner key will be added at station 73 and the spacer 10 then bent to shape and assembled generally in a rectangular configuration, although any conventional perimeter shape is possible.

Thin Walled Spacer 10

An alternative method for providing flexibility to the spacer frame is forming the front 30, sides 26 and the back 28 as thin walled structures as shown in FIGS. 2E and 5C to facilitate flexing. The dimensions of these components may be 0.003″-0.035″, or more preferably 0.010″-0.025″, or most preferably 0.015″-0.020.” These dimensions in a aluminum, stainless steel or plastic structure provide for a flexible tube shape for the spacer frame that allows the assembly to be delivered as a coil to the in situ assembly as shown in FIG. 5C.

The thin walled construction as shown may not make a spacer 10 “flexible” (i.e. some deformation may be required for corner formation) depending upon the particular alloy or material and tube shape used for the spacer frame but the “thin walled” structure will make it easier to “bend” to facilitate spacer 10 formation.

Inverted Notched Spacer 10′

The use of notches across the back 28 and into the sides 26 to form openings 32 of the invention can be used to provide a “flexible” spacer frame as noted above. The number, spacing and width of these notches can be selected to obtain the desired flexing and to control and provide desired interaction with the gap and the desiccant matrix in the finished IGU 20.

As shown in FIGS. 8 and 13A and B the notches allow the spacer frame to be “flipped” or “inverted” forming spacer 10′ of FIG. 8 and positioning the surface that was back 30 in the above described embodiments (now the front by definition) to the inside of the IGU 20 and the surface that was the front 30 in the earlier embodiments (now the back by definition used in this application) to the exterior of the IGU. FIGS. 8 and 13A and B also schematically illustrate the “notching” of an interior corner to accommodate the corner formation in what is a more customary fashion. The spacers 10 and 10′ of the present invention can be utilized with conventional corner forming machines (i.e. notching and bending machines).

Adjustable Spacer 10

FIGS. 2C and 2D illustrate a further embodiment of the spacer 10 in which the spacer frame is formed by overlapping U-shaped channels as shown. The first advantage of this structure is it is an alternative and easy method for placing the desiccant within the interior 34 without the need for holes 32, per se. In both these embodiments, one C channel as shown receives the desiccant 36 and then the mating C-Channel is attached and attached, such as welding in position. The film 40 will seal the unit and allow for the separate c-channels to be used to form the spacer frame as shown.

This structure as used in FIGS. 2C allows the U-shaped members to be slid relative to each other, prior to spacer formation, to adjust the gap height as desired. In this manner a few number of frame forming components (C-Channels) can be used to accommodate spacer shapes of varying heights for different air gap sizes. The spacer frame components must be fixed to each other at a desired position prior to forming the spacer. The fixation may be by welding, ultrasonic welding, glues, mechanical fasteners or the like. The film 40 in these embodiments makes the multi-component construction shown possible and easily sealed in the completed unit.

FIG. 2D allows for width adjustment analogous to the height adjustment of FIG. 2C, which may be useful for increasing the area of the primary seal, but the main advantage offered by this design is the ease of desiccant placement prior to coupling the spacer frame halves.

In Situ and Pre-Formed Spacers 10 and 10′

As discussed above aspect of the present invention provides a spacer 10 with a hollow interior 34 in which a series of holes 32, such as notches, are present on a back surface thereof to assist in desiccant filling at spaced locations along the spacer frame, wherein the holes 32 are sealed with a sealant such as, in one example, a metallic tape 40 extending or wrapping around the entire perimeter of the spacer 10.

This design allows the spacer 10 to be easily filled with desiccant matrix and can allow for the filling process to be accomplished, in situ. “In situ” in this context means at or on the IG assembly line. With in situ spacer formation there is less waste of material due to over exposed desiccant.

There is nothing in the spacer 10 designs that prevent pre-formation of the complete spacer 10 and shipping such to the IG line in conventional sealed packaging. It is envisioned that closed tube embodiments of the spacer 10 (such as shown in FIGS. 2A-2D actually improve on prior art “pre-formation” techniques in that the sealed structure can provide an indefinite shelf life to the product where metal is used for the spacer frame and where “breather holes” if any are provided in situ immediately preceding spacer 10 application to the IGU. A coil of sealed spacer 10 may be easily preformed and packaged with a plug at a leading and trailing end to seal the interior 34 till use and the preformed spacer shipped to the assembly line. The leading end with the plug can be removed (trimmed) during final spacer 10 application to the IGU at the assembly line. Thus the present invention is applicable to and provides some further advantages to pre-formation of the spacer 10.

As discussed above one key aspect of the present invention in select embodiments provide a flexible spacer with a hollow interior which is sufficiently flexible as to be supplied in coil form to an IG assembly line. The flexibility can be provided to the spacer through the construction of a thin-walled profile, a plurality of kerfs or notches across the back of the spacer frame into the sides, a plurality of kerfs or notches across the front of the spacer frame into the sides, a plurality of kerfs or notches across the opposed sides of the spacer frame, and mixtures and combinations of these design features. The flexibility of the spacer can also more easily allow for the in situ assembly of the final spacer. Again, “in situ” in this context means at or on the IG assembly line. Additionally nothing in this embodiment prevents its use in a preformed spacer application.

It should be apparent that certain aspects of the present invention have independent utility, such as the flexibility provided by the notched design. The notches do allow for the easy application of desiccant into the interior as a preferred implementation as discussed above. However nothing prevents the notched flexible design or the thin walled design from being used with an “external desiccant layer” on the front surface 30, if this is desired by the IGU design.

One aspect of the present invention provides an apparatus for wrapping a spacer frame with a flexible one piece free film entirely around the perimeter of the spacer frame. The apparatus for wrapping of the spacer frame can also more easily allow for the in situ assembly of the final spacer. Additionally nothing in this embodiment prevents its use in a preformed spacer application.

While the invention has been shown in several particular embodiments it should be clear that various modifications may be made to the present invention without departing from the spirit and scope thereof. The scope of the present invention is defined by the appended claims and equivalents thereto.

1. A method of forming a spacer for an insulated glass unit comprising:
Forming a spacer frame with a back surface and a pair of opposed sides which define a hollow interior;
Introducing desiccant material into the hollow interior through the back surface at a series of spaced locations along the back surface; and
Sealing the back surface of the spacer frame.

2. The method of forming a spacer according to claim 1 further including the step of forming a series of holes through the back surface.

3. The method of forming a spacer according to claim 2 wherein each hole in the series of holes in the back surface are notches extending across the back surface and into the sides.

4. The method of forming a spacer according to claim 3 wherein the spacer includes a front and each notch extends through each side to the front and provides flexibility to the spacer frame.

5. The method of forming a spacer according to claim 2 wherein the step of sealing the back surface of the spacer frame includes wrapping the entire perimeter of the back with a one piece film.

6. The method of forming a spacer according to claim 5 wherein the film covers the back surface and at least a portion of the sides.

7. The method of forming a spacer according to claim 5 wherein the film covers the back surface and substantially all of the sides.

8. The method of forming a spacer according to claim 5 wherein the step of wrapping the entire perimeter of the back with a one piece film includes overlapping of the film for a portion of the perimeter of the spacer frame.

9. The method of forming a spacer according to claim 1 wherein the step of introducing desiccant material into the hollow interior through the back surface at a series of spaced locations along the back surface is performed in situ at an IGU assembly line.

10. The method of forming a spacer according to claim 9 wherein the spacer frame is supplied in coiled form prior to the step of introducing the desiccant material.

11. A spacer for an insulated glass unit comprising:
A spacer frame having at least a pair of spaced sides and a back extending between the sides wherein the back and pair of sides define a hollow interior, wherein each side is configured to be positioned adjacent a lite of an insulated glass unit;
Desiccant material within at least a part of the hollow interior; and
A one piece free film coupled to spacer frame, wherein the one piece film is covering the entire outer facing surface of the back the spacer frame and is completely encircling the outer facing outer perimeter of the spacer frame.

12. The spacer for an insulated glass unit of claim 11 wherein the one piece free film covers at least a portion of the outer facing surface of each of the sides of the spacer frame.

13. The spacer for an insulated glass unit of claim 12 wherein the one piece free film is a metalized film with an adhesive.

14. The spacer for an insulated glass unit of claim 13 wherein the spacer frame includes four lineal portions and the spacer further include key coupling members wherein the key coupling members are corner coupling members and four corner key coupling members are provided.

15. The spacer for an insulated glass unit of claim 14 wherein the one piece free film overlaps itself on one lineal portion.

16. The spacer for an insulated glass unit of claim 15 wherein the one piece free film covers substantially the entire outer facing surface of each of the sides of each lineal portion.

17. The spacer for an insulated glass unit of claim 14 wherein the back of at least one lineal portion includes openings there through extending to the hollow interior.

18. The spacer for an insulated glass unit of claim 14 wherein each lineal portion includes a front extending between the sides at an interior end thereof.

19. The spacer for an insulated glass unit of claim 11 wherein the one piece free film is a polyester film with an adhesive.

20. An insulated glass unit comprising:
A plurality of lites, each lite spaced from an adjacent lite by a gap;
A spacer between each adjacent pair of lites and coupled to the lites, each spacer including
i) A spacer frame having at least a pair of spaced sides and a back extending between the sides wherein the back and pair of sides define a hollow interior, wherein each side is configured to be positioned adjacent a lite of the insulated glass unit,
ii) Desiccant material within at least a part of the hollow interior; and
iii) A one piece free film coupled to the spacer frame, wherein the one piece film is covering the entire outer facing surface of the back of spacer frame and is completely encircling the outer facing outer perimeter of the spacer frame; and
A primary seal between the one piece free film along each side of the spacer frame and one adjacent lite, wherein the primary seal extends the entire perimeter of the spacer.

21.-100. (canceled)
